(19) United States
(12) Patent Application Publication
(10) Pub. No.: US 2010/0037736 A1
(43) Pub. Date: Feb. 18, 2010

(54) TOOL KIT

(76) Inventor: Hsin Fa Kang, Tainan City (TW)

Correspondence Address: Kang Hsin Fa, P.O. BOX 90, Tainan City, 70499, TW

(21) Appl. No.: 12/190,603

(22) Filed: Aug. 13, 2008

(51) Int. Cl. B25B 23/16

(52) U.S. Cl. 81/177.7; 81/177.4

(57) ABSTRACT

A tool kit includes two opposite grips sets respectively provided with two combining plates connected by connecting rods having tools pivotally fitted thereon. Each combining plate of one grip set has its edge disposed with a rail groove having its center cut with a notch and its opposite inner walls respectively bored with a lengthwise engage slot. Each combining plate of the other grip set has its connecting edge secured with a position projecting rail corresponding with the rail groove, and having its center fixed with connecting projection matching with the notch of the rail groove and its opposite sides respectively provided with an engage bar to be inserted in the engage slot. Thus, mutual engagement of the rail grooves and the position projecting rails forms a large combination area to increase frictional force and enable the two grip sets to be stably combined together.

### BACKGROUND OF THE INVENTION

1. Field of the Invention

This invention relates to a tool kit, particularly to one including two grips respectively provided with two combining plates able to be quickly and stably combined together to make up a tool kit convenient to be carried around for use.

2. Description of the Prior Art

A conventional tool kit devised by the inventor of this invention and disclosed in a U.S. Pat. No. 7,146,889, titled “TOOL KIT” is provided with a first plate grip set and a second plate grip set having their insides respectively and pivotally assembled with tools respectively having one end bored with a fitting hole. A connecting member is inserted through the fitting holes of the tools for pivotally keeping all the tools of the tool kit between the two plate grip sets. The first plate grip set has its lengthwise edge bored with a dovetail-shaped rail groove, while the second plate grip set has its lengthwise edge formed with a dovetail-shaped projecting rail to be fitted in the rail groove of the first plate grip set for quickly combining the two plate grip sets together to make up a tool kit convenient to be carried around for use. Further, the rail groove of the first plate grip set is fixed thereon with a projecting ball at a proper location, while the projecting rail of the second plate grip set is formed with an engage recess at a proper location to be engaged with the projecting ball for stably combining the two plate grip sets together. However, after being used for a long period of time, the projecting ball of the first plate grip set and the engage recess of the second plate grip set will be worn off and unable to be firmly engaged with each other, likely to let the two plate grip sets slip off.

### SUMMARY OF THE INVENTION

This invention is devised to offer a tool kit having two grip sets respectively disposed with two combining plates able to be quickly and stably combined together to make up a tool kit that is convenient to be carried about for use.

The feature of this invention is that each combining plate of one grip set has its lengthwise edge provided with a rail groove having its center cut with an elongate notch and its opposite inner walls respectively bored with an engage slot, while each combining plate of the other grip set has its connecting edge lengthwise fixed with a position projecting rail having its center disposed with an elongate connecting projection to match with the elongate notch of the rail groove, and its opposite sides respectively set with an elongate engage bar to be correspondingly inserted in the engage slot of the rail groove.

### BRIEF DESCRIPTION OF DRAWINGS

This invention will be better understood by referring to the accompanying drawings, wherein:

FIG. 1 is an exploded perspective view of a first preferred embodiment of a tool kit in the present invention;

FIG. 2 is a perspective view of the first preferred embodiment of the tool kit being combined in the present invention;

FIG. 3 is a perspective view of the first preferred embodiment of the tool kit already combined in the present invention;

FIG. 4 is an upper cross-sectional view of the first preferred embodiment of the tool kit in the present invention; and

FIG. 5 is an upper cross-sectional view of a second preferred embodiment of a tool kit in the present invention.

### DETAILED DESCRIPTION OF THE PREFERRED EMBODIMENT

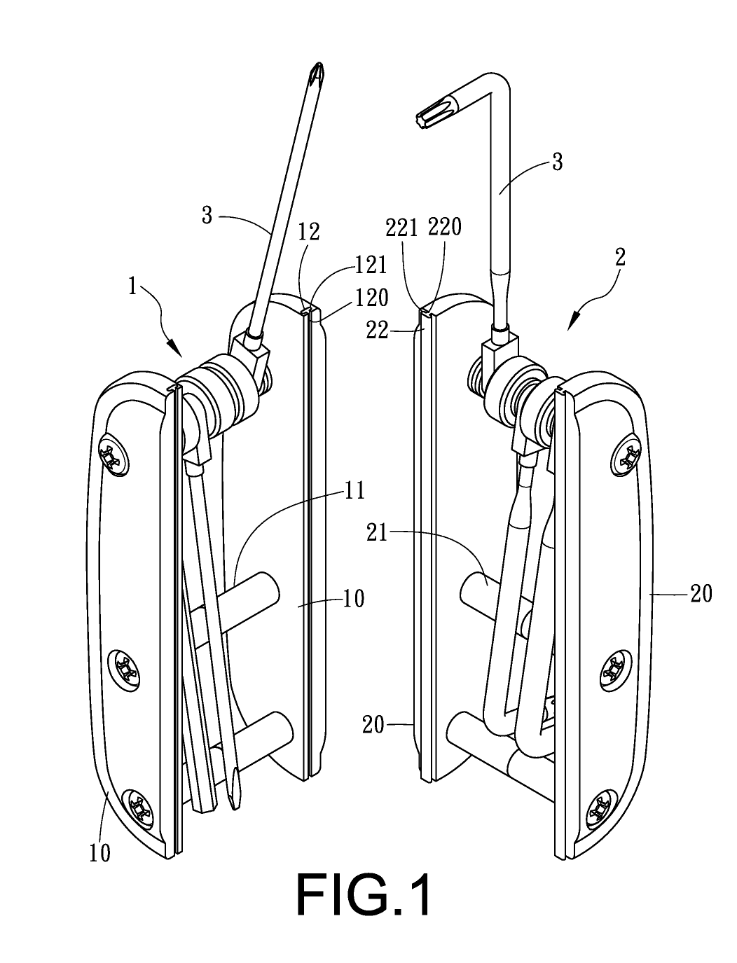

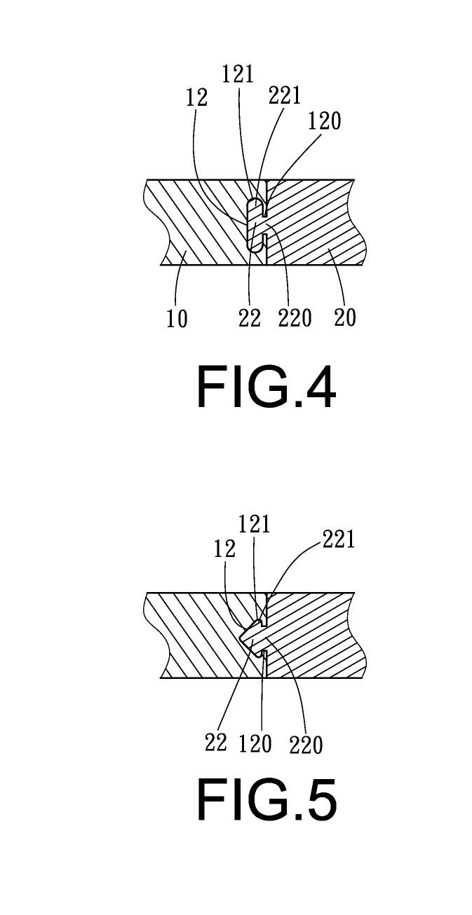

A first preferred embodiment of a tool kit in the present invention, as shown in FIGS. 1 and 4, includes a first grip set 1 and a second grip set 2 opposite to each other and respectively provided with two combining plates 10 and 20. The two combining plates 10 of the first grip set 1 and the two combining plates 20 of the second grip 2 are respectively connected by connecting rods 11 and 21, which respectively have several tools 3 pivotally fitted thereon. Each combining plate 10 of the first grip set 1 has its lengthwise edge disposed with a rail groove 12 shaped like a T and having its center cut with an elongate notch 120 and its opposite inner walls respectively bored with a lengthwise engage slot 121. Each combining plate 20 of the second grip set 2 has its connecting edge disposed with a T-shaped position projecting rail 22 to be inserted in the rail groove 12 of the combining plate 10 of the first grip set 1. The position projecting rail 22 has its center fixed thereon with an elongate connecting projection 220 to match with the elongate notch 120 of the rail groove 12 of the combining plate 10, and its opposite sides respectively provided with an engage bar 221 to be inserted in the engage slot 121 of the rail groove 12 of the combining plate 10.

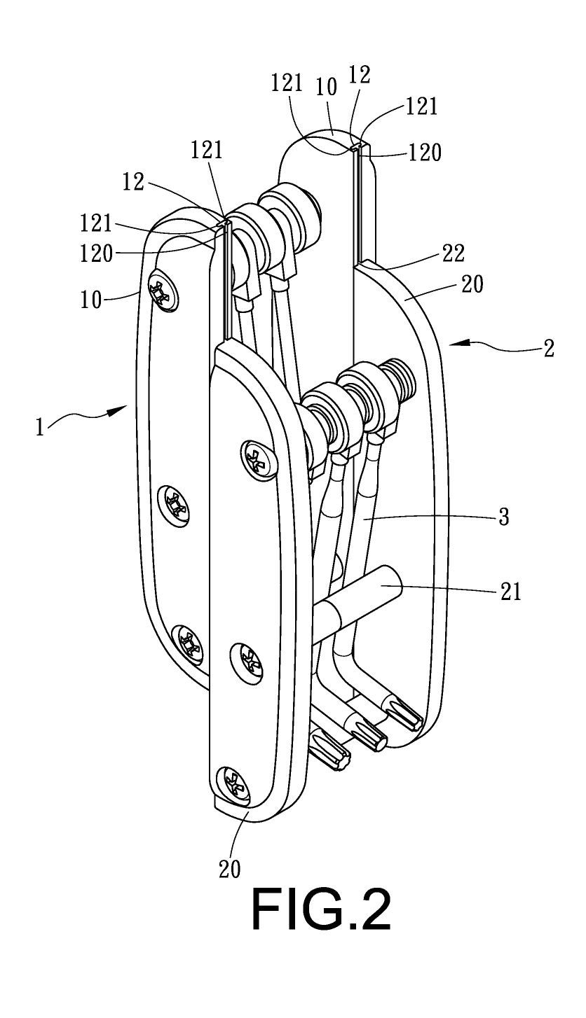

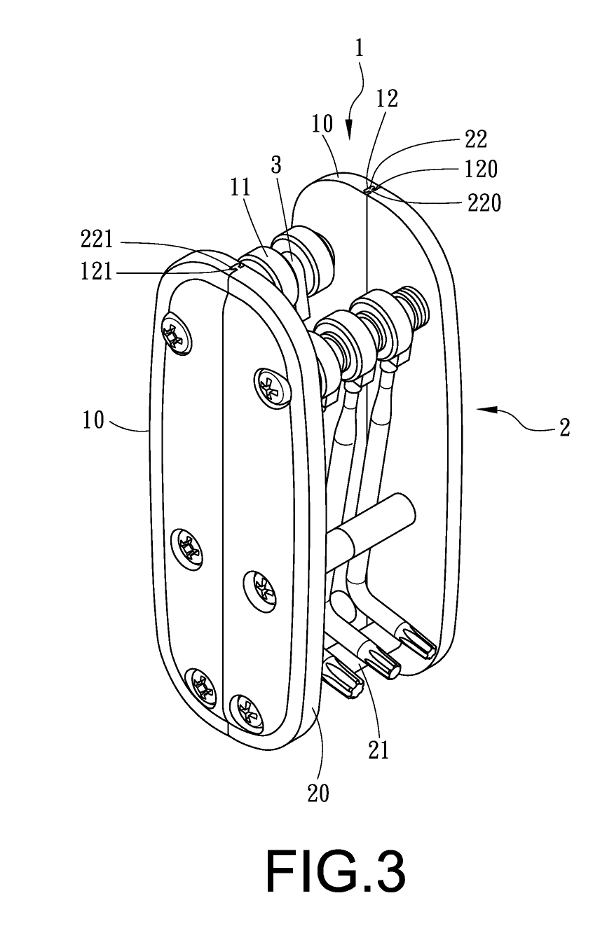

In assembling, as shown in FIGS. 2, 3 and 4, the two combining plates 10 of the first grip set 1 are respectively combined with the two combining plates 20 of the second grip set 2 by having the two T-shaped rail grooves 12 respectively fitted with the two T-shaped projecting rails 22, able to form a comparatively large combination area to increase frictional force and enabling the two grip sets 1 and 2 to be stably combined together not easy to slip off.

A second preferred embodiment of a tool kit in the present invention, as shown in FIG. 5, has almost the same structure as that described in the first preferred embodiment, except that the rail grooves 12 in the connecting edges of the first grip 1 and the position projecting rails 22 on the connecting edges of the second grip 2 are respectively shaped as an arrowhead. Each rail groove 12 of the first grip 1 has its center cut with an elongate notch 120 and its opposite inner walls respectively bored with a lengthwise engage slot 121, while each position projecting rail 22 of the second grip 2 has its center provided with an elongate connecting projection 220 to correspond with the elongate notch 120 the rail groove 12 and its opposite sides respectively disposed With an engage bar 221 to be correspondingly inserted in the engage slot 121 of the rail groove 12. Thus, mutual engagement of the arrowhead-shaped rail grooves 12 and the position projecting rails 22 not only forms a comparatively large combination area to increase frictional force but also enables the two grip sets 1, 2 to be combined stably never to be disengaged.

While the preferred embodiments of the invention have been described above, it will be recognized and understood that various modifications may be made therein and the appended claims are intended to cover all such modifications that may fall within the spirit and scope of the invention.

What is claimed is:

1. A tool kit comprising two opposite grip sets, said two grips respectively disposed with two combining plates, said two combining plates connected by connecting rods, said connecting rods having several tools pivotally fitted thereon: and,
characterized by each said combining plate of one of said first grip sets having its lengthwise edge provided with a rail groove, said rail groove cut with a notch in the center, said rail groove having its opposite inner walls respectively bored with an engage slot, each said combining plate of another of said grip sets having its lengthwise edge fixed with a position projecting rail to correspond with said rail groove, said position projecting rail having its center fixed with an elongate connecting projection to match with said notch of said rail groove, said position projecting rail having its opposite sides respectively secured with an engage bar to be, correspondingly inserted in said engage slot.

2. The tool kit as claimed in claim 1, wherein said rail groove and said position projecting rail of said grips are respectively shaped like a T.

3. The tool kit as claimed in claim 1, wherein said rail groove and said position projecting rail of said grips are respectively shaped like an arrowhead.
